(19) United States
(12) Patent Application Publication
(10) Pub. No.: US 2016/0077551 A1
(43) Pub. Date: Mar. 17, 2016

(54) PORTABLE APPARATUS AND METHOD FOR CONTROLLING PORTABLE APPARATUS

(71) Applicant: KYOCERA Corporation, Kyoto (JP)

(72) Inventors: Keisuke FUJINO, Nishinomiya-shi (JP); Takashi SUGIYAMA, Kyoto-shi (JP)

(73) Assignee: KYOCERA Corporation

(21) Appl. No.: 14/952,727

(22) Filed: Nov. 25, 2015

Related U.S. Application Data
(63) Continuation of application No. PCT/JP2014/064286, filed on May 29, 2014.

(30) Foreign Application Priority Data
May 29, 2013 (JP) 2013-113214
May 29, 2013 (JP) 2013-113285

(51) Int. Cl. G06F 1/16; G06F 3/0488; G06F 3/041

(52) U.S. Cl. CPC G06F 1/1643; G06F 3/0412; G06F 3/0416; G06F 3/04883

(57) ABSTRACT

A display area is provided on a front face of an apparatus case of a portable apparatus. An operation detection module detects an operation performed with an operating finger on the display area. A first detection module detects a contact location of a holding finger holding the apparatus case. A second detection module detects a tilt angle of the housing with respect to a reference position of the housing. If the processor detects a change in the contact location, and the second detection module detects a change in the tilt angle of the housing, a at least one processor translates a display screen in a direction away from the contact location, and displays the display screen in the display area.

### CROSS-REFERENCE TO RELATED APPLICATIONS

The present application is a continuation of International Application No. PCT/JP2014/064286, filed on May 29, 2014, which claims the benefit of Japanese Patent Application No. 2013-113214, filed on May 29, 2013, and Japanese Patent Application No. 2013-113285, filed on May 29, 2013. International Application No. PCT/JP2014/064286 is entitled “PORTABLE APPARATUS AND METHOD FOR CONTROLLING PORTABLE APPARATUS”, and both Japanese Patent Applications No. 2013-113214 and No. 2013-113285 are entitled “PORTABLE APPARATUS, CONTROL PROGRAM, AND METHOD FOR CONTROLLING PORTABLE APPARATUS”. The contents of these applications are incorporated herein by reference in their entirety.

### FIELD

Embodiments of the present disclosure relate to a portable apparatus and a method for controlling a display module of a portable apparatus.

### BACKGROUND

Various techniques concerning portable apparatuses have been proposed.

### SUMMARY

A portable apparatus and a method for controlling a portable apparatus are disclosed. In one embodiment, a portable apparatus includes a housing, a display area, an operation detection module, at least one first detection module, a second detection module, and at least one processor. The display area is located on a front face of the housing. The operation detection module is configured to detect an operation performed with an operating finger on the display area. The at least one first detection module is configured to detect a contact location of a holding finger holding the housing. The second detection module is configured to detect a tilt angle of the housing with respect to a reference position of the housing. The at least one processor is configured to translate, if the processor detects a change in the contact location, and the second detection module detects a change in the tilt angle of the housing, a display screen in a direction away from the contact location, and display the display screen in the display area.

In one embodiment, a portable apparatus includes a housing, a display area, a storage module, a detection module, and at least on processor. The display area is located on a front face of the housing. The storage module is configured to store a plurality of application programs. The detection module is configured to detect an input by a user. The at least on processor is configured to display a portion of a first display screen in a main area being a portion of the display area, and display a portion of a second display screen in a sub area being a portion of the display area other than the main area. The first display screen is displayed in the display area when a first application program is run. The second display screen is displayed in the display area when a second application program different from the first application program is run.

In one embodiment, a method for controlling a portable apparatus includes the step of translating, if a change in contact location of a holding finger holding a housing and a change in tilt angle of the housing are both detected, a display screen in a direction away from the contact location, and displaying the display screen in a display area. The portable apparatus includes the housing, the display area, an operation detection module, a holding finger detection module, and a tilt detection module. The display area is provided on a front face of the housing. The operation detection module is configured to detect an operation performed with an operating finger on the display area. The holding finger detection module is provided on the housing and is configured to detect the contact location. The tilt detection module is configured to detect the tilt angle of the housing with respect to a reference position of the housing.

In one embodiment, a method for controlling a portable apparatus includes the step of displaying a portion of a first display screen in a main area being a portion of a display area, and displaying a portion of a second display screen in a sub area being a portion of the display area other than the main area. The first display screen is displayed in the display area when a first application program is run. The second display screen is displayed in the display area when a second application program different from the first application program is run. The portable apparatus includes a housing, the display area, a storage module, and a detection module. The display area is provided on a front face of the housing. The storage module is configured to store a plurality of application programs. The detection module is configured to detect an input by a user.

### BRIEF DESCRIPTION OF DRAWINGS

FIG. 1 illustrates a perspective view showing a conceptual example of conceptual appearance of a portable apparatus.

FIG. 2 illustrates a back face view showing a conceptual example of conceptual appearance of the portable apparatus.

FIG. 3 illustrates a conceptual example of holding the portable apparatus with the right hand.

FIG. 4 illustrates a conceptual example of holding the portable apparatus with the left hand.

FIG. 5 illustrates an example of electrical configuration of the portable apparatus.

FIG. 6 illustrates an example of conceptual configuration of a touch sensor.

FIG. 7 illustrates examples of results of detection performed by the touch sensor.

FIG. 8 illustrates a flowchart showing an example of operation of a control module.

FIG. 9 illustrates a conceptual diagram showing examples of a display area and an operating finger.

FIG. 10 illustrates a conceptual diagram showing examples of the display area and the operating finger.

FIG. 11 illustrates a flowchart showing an example of operation of the control module.

FIG. 12 illustrates a conceptual example of holding the portable apparatus with the left hand.

FIG. 13 illustrates a conceptual diagram showing examples of the display area and the operating finger.

FIG. 14 illustrates a conceptual diagram showing examples of the display area and the operating finger.

FIG. 15 illustrates an operation performed with a holding finger using the touch sensor.

FIG. 16 illustrates a schematic example of the display area.

FIG. 17 illustrates a schematic example of the display area.

FIG. 18 illustrates a schematic example of the display area.

FIG. 19 illustrates a schematic example of the display area.

FIG. 20 illustrates a schematic example of the display area.

FIG. 21 illustrates a schematic example of the display area.

FIG. 22 illustrates a flowchart showing an example of operation of the control module.

### DETAILED DESCRIPTION

<Appearance of Portable Apparatus>

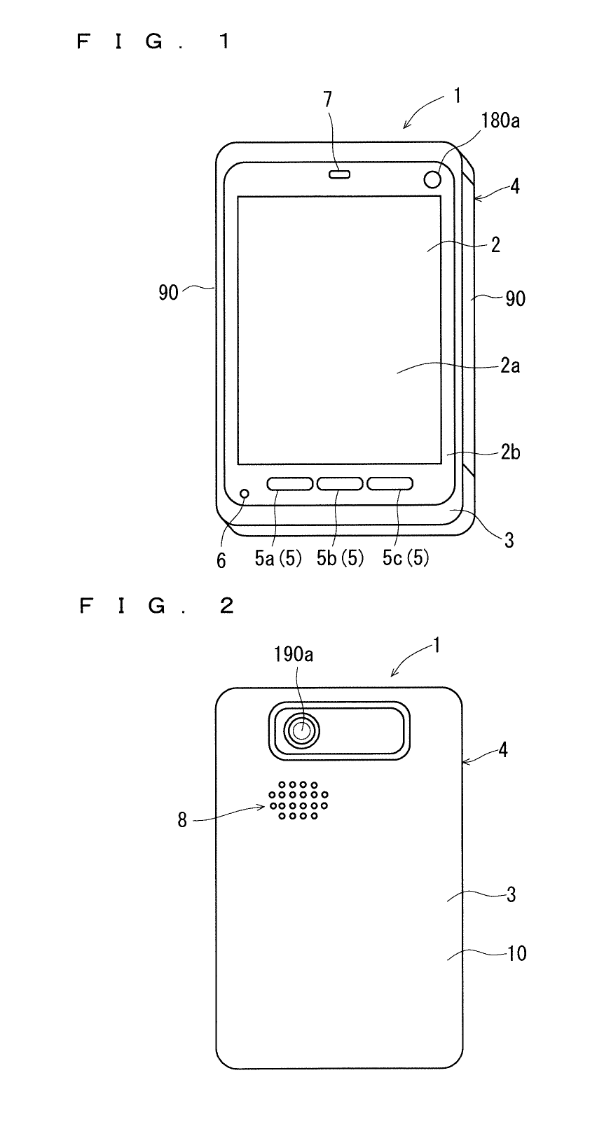

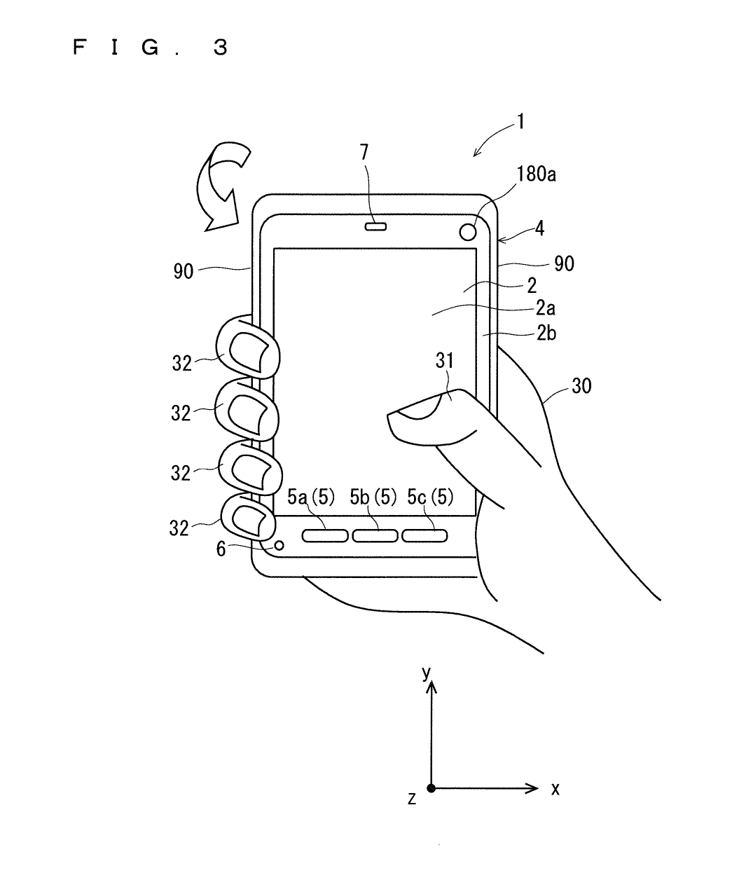

FIG. 1 illustrates a perspective view showing the appearance of a portable apparatus 1 according to one embodiment as viewed from a front face side. FIG. 2 illustrates a back face view showing an overview of the portable apparatus 1. The portable apparatus 1 is a portable telephone, for example, and can communicate with another communication apparatus through a base station, a server, and the like. As illustrated in FIGS. 1 and 2, the portable apparatus 1 includes a cover panel 2 and a case part 3. The cover panel 2 and the case part 3 may be combined with each other to form a housing (hereinafter, also referred to as an apparatus case) 4. The housing 4 may have an approximately rectangular plate-like shape in a plan view.

The cover panel 2 may be approximately rectangular in a plan view, and form a portion of a front face of the portable apparatus 1 other than a peripheral portion. The cover panel 2 is made, for example, of transparent glass or a transparent acrylic resin. The case part 3 includes the peripheral portion of the front face, side faces, and a back face of the portable apparatus 1. The case part 3 is made, for example, of a polycarbonate resin.

A display area 2a is located on a front face of the cover panel 2. In the display area 2a, a variety of information including characters, signs, figures, and images may be displayed. Only a single display area 2a is herein located on the portable apparatus 1, and the display area 2a may be rectangular in a plan view, for example. A peripheral portion 2b surrounding the display area 2a of the cover panel 2 may be black, for example, because a film or the like has been stuck on the peripheral portion 2b. The peripheral portion 2b is a non-display portion on which no information is displayed. A touch panel 130, which is describe below, has been stuck on a back face of the cover panel 2. A user can provide various instructions to the portable apparatus 1 by operating the display area 2a on the front face of the portable apparatus 1 with a finger and the like. The user can provide various instructions to the portable apparatus 1 also by operating the display area 2a with an operator other than the finger, such as, a pen for electrostatic touch panels including a stylus pen.

A home key 5a, a menu key 5b, and a back key 5c are provided in the apparatus case 4. The home key 5a, the menu key 5b, and the back key 5c are hardware keys, and surfaces of the home key 5a, the menu key 5b, and the back key 5c are exposed from a lower end portion of the front face of the cover panel 2. The home key 5a is an operation key to display a home screen (an initial screen) in the display area 2a. The menu key 5b is an operation key to display an option menu screen in the display area 2a. The back key 5c is an operation key to return display in the display area 2a to the preceding display. Hereinafter, the home key 5a, the menu key 5b, and the back key 5c are each referred to as an “operation key 5” unless there is a need to particularly distinguish among them. The home key 5a, the menu key 5b, and the back key 5c are not limited to the hardware keys, and may be software keys displayed in the display area 2a so that the touch panel 130 detects an operation performed thereon.

The cover panel 2 has a microphone hole 6 in the lower end portion thereof, and has a receiver hole 7 in an upper end portion thereof. An imaging lens 180a of a front-face-side imaging module 180, which is described below, is exposed from the upper end portion of the front face of the cover panel 2 so as to be visible. As illustrated in FIG. 2, the portable apparatus 1, in other words, the apparatus case 4 has speaker holes 8 in the back face thereof. An imaging lens 190a of a back-face-side imaging module 190, which is described below, is exposed from the back face of the portable apparatus 1 so as to be visible.

Touch sensors 90 are located in the apparatus case 4. The touch sensors 90 are provided at such locations that the touch sensors 90 are in contact with fingers holding the portable apparatus 1. As illustrated in FIG. 3, the user herein can hold the portable apparatus 1 with one hand. In the example of FIG. 3, the user holds the portable apparatus 1 with the right hand 30. In this case, the portable apparatus 1 is held by being sandwiched between the base of the thumb 31 and fingers 32 other than the thumb 31 of the right hand 30. The fingers 32 thus come into contact with a side face (a side face on the left side of FIG. 3) of the portable apparatus 1. The touch sensor 90 is provided on the side face, and can detect movement of the fingers 32. In this case, the user can operate the display area 2a with the thumb 31. Hereinafter, the thumb 31 is also referred to as an operating finger, and the fingers 32 are also referred to as holding fingers.

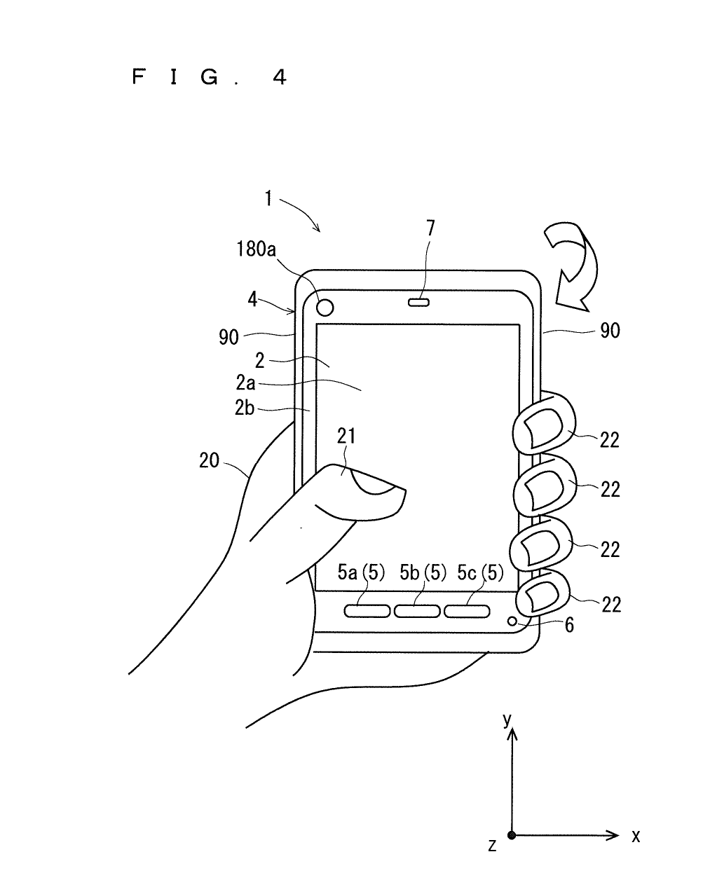

In the example of FIG. 4, the user holds the portable apparatus 1 with the left hand 20. In this case, the portable apparatus 1 is held by being sandwiched between the base of the thumb 21 and fingers 22 other than the thumb 21 of the left hand 20. The fingers 22 thus come into contact with a side face (a side face on the right side of FIG. 4) of the portable apparatus 1. The touch sensor 90 is also provided on the side face, and can detect movement of the fingers 22. In this case, the user can operate the display area 2a with the thumb 21. Hereinafter, the thumb 21 is also referred to as an operating finger, and the fingers 22 are also referred to as holding fingers.

<Electrical Configuration of Portable Apparatus>

FIG. 5 illustrates a block diagram showing electrical configuration of the portable apparatus 1. As illustrated in FIG. 5, the portable apparatus 1 includes a control module 100, a display panel 120, a display control module 122, a detection module 132, and a tilt sensor 92. The portable apparatus 1 further includes a wireless communication module 110, a key operation module 140, a microphone 150, a receiver 160, an external speaker 170, the front-face-side imaging module 180, the back-face-side imaging module 190, and a battery 200. These components of the portable apparatus 1 are housed in the apparatus case 4.

The control module 100 may be a processor, and includes a central processing unit (CPU) 101, a digital signal processor (DSP) 102, and a storage module 103, and can control other components of the portable apparatus 1 to perform overall control of operation of the portable apparatus 1. The storage module 103 may include read only memory (ROM), random access memory (RAM), and the like. The storage module 103 can store a main program 103a, a plurality of application programs 103b (hereinafter, simply referred to as “applications 103b”), and the like. The main program 103a is a control program for controlling operation of the portable apparatus 1, specifically, components, such as the wireless communication module 110 and the display panel 120, of the portable apparatus 1. Various functions of the control module 100 are achieved by the CPU 101 and the DSP 102 running various programs stored in the storage module 103. In FIG. 5, only a single application 103b is shown to avoid complications. Although a single CPU 101 and a single DSP 102 are shown in the example of FIG. 5, a plurality of CPUs 101 and a plurality of DSPs 102 may be used. These CPUs and DSPs may cooperate with each other to achieve various functions. Although the storage module 103 is shown to be included in the control module 100 in the example of FIG. 5, the storage module 103 may be located external to the control module 100. In other words, the storage module 103 may be separated from the control module 100.

The wireless communication module 110 has an antenna 111. The wireless communication module 110 can receive, from the antenna 111 through the base station and the like, a signal from a portable telephone other than the portable apparatus 1 or a communication apparatus, such as a web server, connected to the Internet. The wireless communication module 110 can amplify and down-convert the received signal, and output the resulting signal to the control module 100. The control module 100 can demodulate the received signal as input, for example. The wireless communication module 110 can also up-convert and amplify a transmission signal generated by the control module 100, and wirelessly transmit the up-converted and amplified transmission signal from the antenna 111. The transmission signal transmitted from the antenna 111 is received, through the base station and the like, by the portable telephone other than the portable apparatus 1 or the communication apparatus connected to the Internet.

The display panel 120 is a liquid crystal display panel or an organic EL panel, for example. The display panel 120 can display a variety of information including characters, signs, figures, and images through control by the control module 100 and the display control module 122. Information displayed by the display panel 120 is displayed in the display area 2a located on the front face of the cover panel 2. It can therefore be said that the display panel 120 performs display in the display area 2a.

The display control module 122 can cause the display panel 120 to display a display screen based on an image signal received from the control module 100. For the sake of simplicity, the display panel 120 is hereinafter described to be controlled by the control module 100.

The detection module 132 can detect an input by the user into the portable apparatus 1, and notify the control module 100 of the input. The detection module 132 includes the touch panel 130, the key operation module 140, and the touch sensor 90, for example.

The touch panel 130 can detect an operation performed with an operator, such as an operating finger, on the display area 2a of the cover panel 2. The touch panel 130 is a projected capacitive touch panel, for example, and has been stuck on the back face of the cover panel 2. When the user performs an operation on the display area 2a of the cover panel 2 with the operator, such as the operating finger, a signal corresponding to the operation is input from the touch panel 130 into the control module 100. The control module 100 can specify the details of the operation performed on the display area 2a based on the signal input from the touch panel 130, and perform processing in accordance with the operation.

The touch sensor 90 is located on the apparatus case 4, and can detect movement of the holding fingers. More specifically, the touch sensor 90 can detect a contact location of the touch sensor 90 itself and the holding fingers, and output the contact location to the control module 100. The touch sensor 90 can detect the contact location of the holding fingers, for example, using a similar principle to that used by the touch panel 130. The touch sensor 90, however, is not required to allow visible light to pass therethrough as the touch sensor 90 is not required to have a display function. The control module 100 can know movement of the holding fingers based on a change in contact location detected by the touch sensor 90.

The tilt sensor 92 can detect a tilt angle of the portable apparatus 1 (or the apparatus case 4) with respect to a reference position of the portable apparatus 1. Any position may be set as the reference position. For example, the reference position is a position in which the portable apparatus 1 (more specifically, the cover panel 2) is parallel to the horizontal plane.

The tilt sensor 92 can detect the following two tilt angles. That is to say, the tilt sensor 92 can detect a rotation angle (tilt angle) about one of x, y, and z axes perpendicular to one another and a rotation angle (tilt angle) about another one of the x, y, and z axes. The x, y, and z axes are fixed with respect to the portable apparatus 1, and, as illustrated in FIGS. 3 and 4, axes extending in the horizontal direction, the vertical direction, and a direction perpendicular to the plane of FIGS. 3 and 4 can respectively be used as the x, y, and z axes, for example. A tilt position of the portable apparatus 1 with respect to the reference position of the portable apparatus 1 can be represented by the two tilt angles.

The tilt sensor 92 is an acceleration sensor, for example. The acceleration sensor can detect gravitational acceleration components along the x, y, and z axes caused in the portable apparatus 1. The control module 100 can detect (or calculate) the tilt angle of the portable apparatus 1 from a predetermined geometric relation using the gravitational acceleration components in the respective directions detected by the tilt sensor 92.

The key operation module 140 can detect an operation performed by the user to press each of the operation keys 5. The key operation module 140 can detect pressing of (an operation performed on) each of the operation keys 5. In a case where the operation key 5 is not pressed, the key operation module 140 can output, to the control module 100, a non-operation signal indicating that no operation is performed on the operation key 5. In a case where the operation key 5 is pressed, the key operation module 140 can output, to the control module 100, an operation signal indicating that an operation is performed on the operation key 5. As a result, the control module 100 can judge whether an operation is performed on each of the operation keys 5.

In a case where the key operation module 140 detects pressing of the home key 5a and then detects releasing from the home key 5a, the control module 100 causes the display panel 120 to display the home screen (initial screen). As a result, the home screen is displayed in the display area 2a. In a case where the key operation module 140 detects pressing of the menu key 5b and then detects releasing from the menu key 5b, the control module 100 causes the display panel 120 to display the option menu screen. As a result, the option menu screen is displayed in the display area 2a. In a case where the key operation module 140 detects pressing of the back key 5c and then detects releasing from the back key 5c, the control module 100 causes the display panel 120 to return the display to the preceding display. As a result, the display in the display area 2a is returned to the preceding display.

The microphone 150 can convert sound input from the outside of the portable apparatus 1 into electrical sound signals, and output the electrical sound signals to the control module 100. The sound input from the outside of the portable apparatus 1 is introduced into the portable apparatus 1 through the microphone hole 6 located in the front face of the cover panel 2, and input into the microphone 150.

The external speaker 170 is a dynamic loudspeaker, for example, and can convert electrical sound signals from the control module 100 into sound, and output the sound. The sound output from the external speaker 170 is output to the outside through the speaker holes 8 provided in the back face of the portable apparatus 1. The sound output through the speaker holes 8 can be heard even in a place remote from the portable apparatus 1.

The front-face-side imaging module 180 may include the imaging lens 180a, an imaging device, and the like, and can capture a still image and a moving image based on control by the control module 100. As illustrated in FIG. 1, the imaging lens 180a is located on the front face of the portable apparatus 1, and thus the front-face-side imaging module 180 can capture an image of an object existing at the front face side (the cover panel 2 side) of the portable apparatus 1.

The back-face-side imaging module 190 may include the imaging lens 190a, an imaging device, and the like, and can capture a still image and a moving image based on control by the control module 100. As illustrated in FIG. 2, the imaging lens 190a is located on the back face of the portable apparatus 1, and thus the back-face-side imaging module 190 can capture an image of an object existing at the back face side of the portable apparatus 1.

The receiver 160 can output received sound, and may include a dynamic loudspeaker, for example. The receiver 160 can convert electrical sound signals from the control module 100 into sound, and output the sound. The sound output from the receiver 160 is output to the outside through the receiver hole 7 located in the front face of the portable apparatus 1. The volume of the sound output through the receiver hole 7 is smaller than the volume of the sound output through the speaker holes 8.

The battery 200 can output power to the portable apparatus 1. The power output from the battery 200 is supplied to electronic components included in the control module 100, the wireless communication module 110, and the like of the portable apparatus 1.

The storage module 103 can store the various applications 103b, which achieve various functions of the portable apparatus 1. The storage module 103 can store a telephone application for performing communication using a telephone function, a browser for displaying web sites, and a mail application for creating, viewing, and sending and receiving emails, for example. The storage module 103 can also store a camera application for capturing a still image and a moving image using the front-face-side imaging module 180 and the back-face-side imaging module 190, a television application for watching and recording television programs, a moving image playback control application for performing playback control of moving image data stored in the storage module 103, a music playback control application for performing playback control of music data stored in the storage module 103, and the like.

When the control module 100 reads and runs the applications 103b stored in the storage module 103 during running of the main program 103a stored in the storage module 103, the control module 100 controls other components, such as the wireless communication module 110, the display panel 120, and the receiver 160, of the portable apparatus 1, so that functions (processing) corresponding to the applications 103b are achieved by the portable apparatus 1. For example, if the control module 100 runs the telephone application, the control module 100 controls the wireless communication module 110, the microphone 150, and the receiver 160. As a result, in the portable apparatus 1, voice included in the received signal received by the wireless communication module 110 is output from the receiver 160, and the transmission signal including voice input into the microphone 150 is transmitted from the wireless communication module 110, so that communication using the telephone function is performed with a communication partner apparatus.

<Types of Operation Performed on Display Area>

Examples of a basic operation performed by the user on the display area 2a include a slide operation, a tap operation, a double-tap operation, a flick operation, a pinch-out operation and a pinch-in operation.

The slide operation refers to an operation to move the operator, such as the operating finger, with the operator in contact with or in close proximity to the display area 2a. This means that the slide operation refers to an operation to move the operator in the display area 2a. The user performs the slide operation on the display area 2a, for example, to scroll display in the display area 2a or to switch a page displayed in the display area 2a to another page.

As described above, in one embodiment, the operation to move the operator in the display area 2a includes both the operation to move the operator with the operator in contact with the display area 2a and the operation to move the operator with the operator in close proximity to the display area 2a.

The tap operation refers to an operation to release the operator from the display area 2a immediately after the operator is brought into contact with or into close proximity to the display area 2a. Specifically, the tap operation refers to an operation to release, within a predetermined time period after the operator is brought into contact with or into close proximity to the display area 2a, the operator from the display area 2a at a location where the operator is in contact with or in close proximity to the display area 2a. The user performs the tap operation on the display area 2a, for example, to select an application icon (hereinafter, referred to as an “app icon”) for running one of the applications 103b displayed in the display area 2a to thereby cause the portable apparatus 1 to run the application 103b.

The double-tap operation refers to an operation to perform the tap operation twice within a predetermined time period. The user performs the double-tap operation on the display area 2a, for example, to enlarge a display screen displayed in the display area 2a at a predetermined enlargement ratio, and display the enlarged display screen, or to reduce the display screen at a predetermined reduction ratio, and display the reduced display screen.

The flick operation refers to an operation to wipe the display area 2a with the operator. Specifically, the flick operation refers to an operation to move the operator by a predetermined distance or more within a predetermined time period with the operator in contact with or in close proximity to the display area 2a, and then release the operator from the display area 2a. The user performs the flick operation on the display area 2a, for example, to scroll display in the display area 2a in a direction of the flick operation or to switch a page displayed in the display area 2a to another page.

The pinch-out operation refers to an operation to increase a gap between two operators with the two operators in contact with or in close proximity to the display area 2a. The user performs the pinch-out operation on the display area 2a, for example, to enlarge the display screen in accordance with the gap between the two operators, and display the enlarged display screen in the display area 2a.

The pinch-in operation refers to an operation to reduce a gap between two operators with the two operators in contact with or in close proximity to the display area 2a. The user performs the pinch-in operation on the display area 2a, for example, to reduce the display screen in accordance with the gap between the two operators, and display the reduced display screen in the display area 2a.

<Method for Operating Portable Apparatus>

As illustrated in FIGS. 3 and 4, in a case where the user operates the display area 2a with the thumb while holding the portable apparatus 1 with one hand, the user may find difficulty operating an end portion of the display area 2a. Specifically, in a case where the user holds the portable apparatus 1 with the right hand 30 (see FIG. 3), for example, the user may find difficulty operating an end portion (more specifically, an upper left end portion) of the display area 2a closer to the contact location of the holding fingers 32. This is because the thumb 31 of the right hand 30 hardly reaches the portion. On the other hand, in a case where the user holds the portable apparatus 1 with the left hand 20 (see FIG. 4), the user may find difficulty operating an end portion (more specifically, an upper right end portion) of the display area 2a closer to the contact location of the holding fingers 22. This is because the thumb 21 of the left hand 20 hardly reaches the portion. Such a problem is noticeable in a larger screen in the display area 2a.

An area that is difficult to operate is hereinafter referred to as a difficult-to-operate area. Thus, the difficult-to-operate area is the upper left end portion of the display area 2a in the case of operating the portable apparatus 1 with the thumb 31 of the right hand 30, and is the upper right end portion of the display area 2a in the case of operating the portable apparatus 1 with the thumb 21 of the left hand 20. An area that the operating finger easily reaches is referred to as an easy-to-operate area.

Operation performed when the user tries to operate the difficult-to-operate area is described next. A case where the user operates the difficult-to-operate area with the thumb 31 while holding the portable apparatus 1 with the right hand 30 (see FIG. 3) is described first. In this case, the user tries to operate the difficult-to-operate area by stretching the thumb 31 to the difficult-to-operate area while tilting the portable apparatus 1 so that the difficult-to-operate area approaches the thumb 31. More specifically, the user stretches the thumb 31 while tilting an upper left end portion of the portable apparatus 1 towards the user (towards the front of the plane of FIG. 3) relative to a lower right end portion of the portable apparatus 1. The thumb 31 is thereby brought into close proximity to or into contact with the difficult-to-operate area.

Such a change in tilt position of the portable apparatus 1 is made by pushing the back face of the portable apparatus 1 towards the user with the holding fingers 32. For example, the user pushes the back face with the holding fingers 32 while moving the holding fingers 32 from the side face to the back face of the portable apparatus 1.

The fact that the user tries to operate the difficult-to-operate area is thus known by detecting movement of the holding fingers 32 and a change in tilt position of the portable apparatus 1.

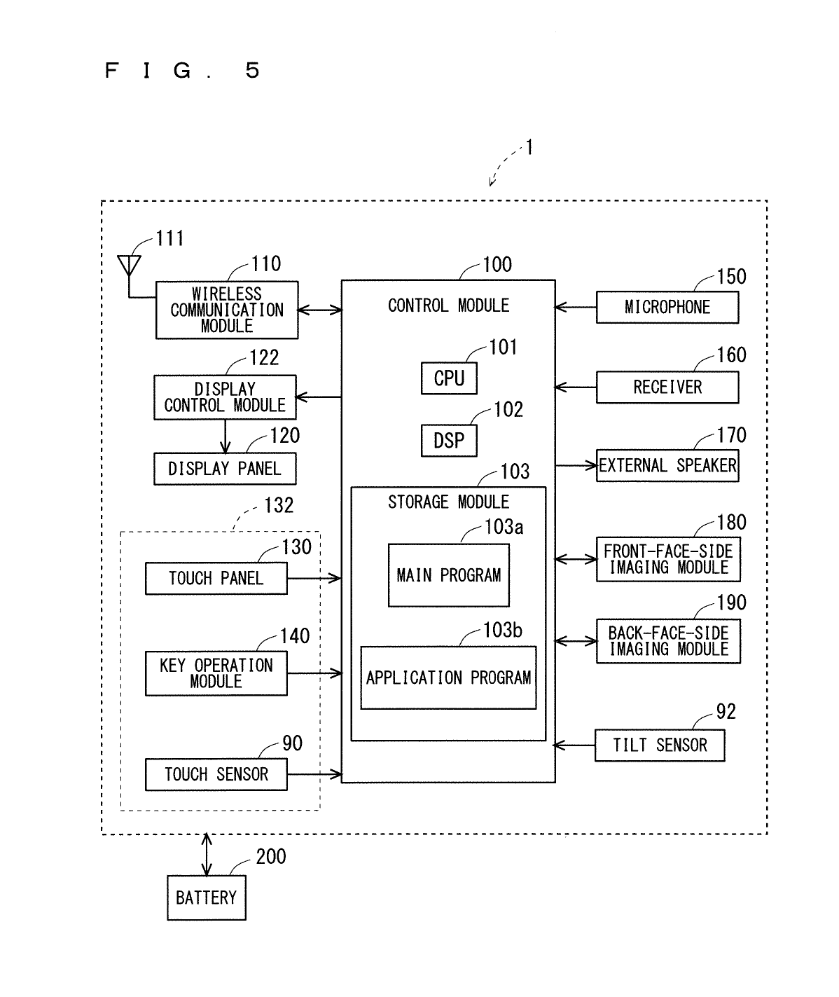

Movement of the holding fingers 32 is detected by the touch sensor 90. FIG. 6 illustrates a plan view schematically showing the touch sensor 90 located on the left side of the plane of FIG. 3. The touch sensor 90 is approximately rectangular in a plan view (as viewed from a direction perpendicular to the side faces of the portable apparatus 1). One side of the touch sensor 90 on the left side of the plane of FIG. 6 is herein defined to be located on the back face side of the portable apparatus 1, and another side of the touch sensor 90 on the right side of the plane of FIG. 6 is herein defined to be located on the front face side of the portable apparatus 1. In FIG. 6, parallel lines a, b, c, and d are arranged in the stated order from the front face to the back face. These lines a, b, c, and d are imaginary lines, and indicate locations in the touch sensor 90 in the horizontal direction (z-axis direction) of the plane of FIG. 6.

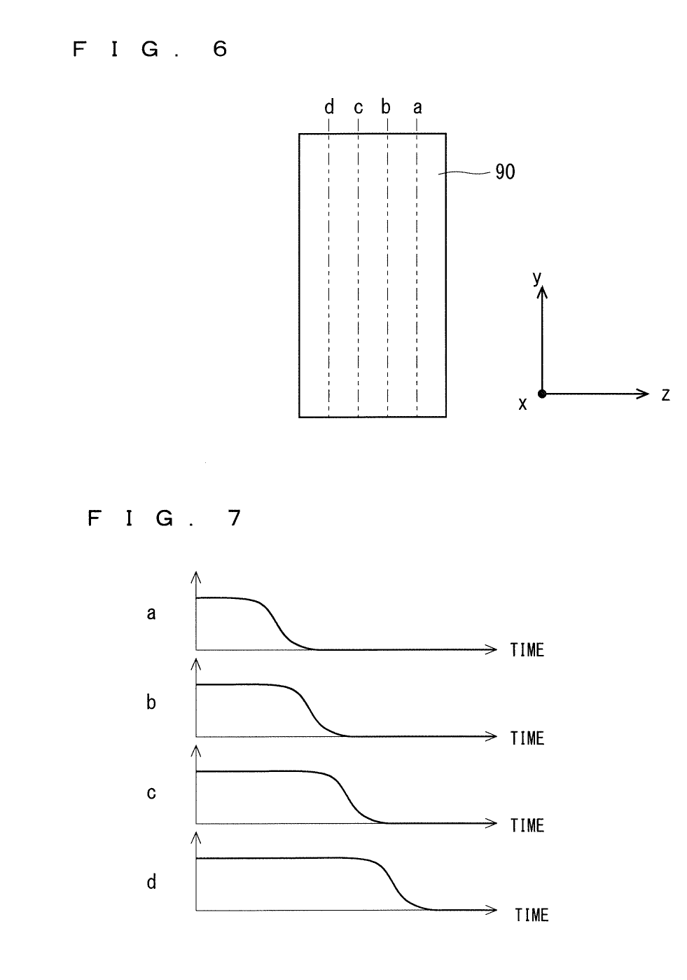

FIG. 7 illustrates results of detection performed by the touch sensor 90 with respect to one of the holding fingers 32 on each of the lines a, b, c, and d. That is to say, a contact location of the holding finger 32 in the horizontal direction of the plane of FIG. 6 is illustrated. FIG. 7 illustrates a change in detected value (e.g., current value) caused by contact with the holding finger 32 over time. Contact with the holding finger 32 is detected in a case where the detected value is large.

In the example of FIG. 7, contact with the holding finger 32 is detected on each of the lines a, b, c, and d in an early stage. This means that the holding finger 32 is in contact with the side face of the portable apparatus 1 from the back face to the front face. When the user moves the holding finger 32 as described above in an attempt to operate the difficult-to-operate area, the holding finger 32 is released from the side face first from the front face. In FIG. 7, releasing of the holding finger 32 is thus first detected on the line a, and is then detected on the lines b, c, and d in the stated order.

As described above, the control module 100 can detect movement of the holding finger 32 using the touch sensor 90. For example, the control module 100 judges whether the amount of change (herein, the distance to the lines a, b, c, and d) in contact location of the holding finger detected by the touch sensor 90 exceeds a predetermined threshold. If the amount of change exceeds the threshold, the control module 100 judges that the holding finger 32 has moved.

In the example of FIG. 7, description is made by showing the detected values at locations in the z-axis direction, for the sake of simplicity. The touch sensor 90 actually detects values at locations in the y-axis direction and in the z-axis direction. Movement of the holding finger 32 may be detected based on the amount of change in contact location in the y-axis direction as the holding finger 32 can move in the y-axis direction when the user tries to operate the difficult-to-operate area.

The tilt sensor 92 detects the tilt angle of the portable apparatus 1 with respect to the reference position of the portable apparatus 1. A change in tilt position of the portable apparatus 1 can thus be detected based on a change in tilt angle over time. For example, the control module 100 judges whether the amount of change in tilt angle in a predetermined time period exceeds a threshold (e.g., a few degrees). If the amount of change in tilt angle exceeds the threshold, the control module 100 judges that the tilt position of the portable apparatus 1 has changed.

As described above, the touch sensor 90 can detect movement (the change in contact location) of the holding finger 32, and the tilt sensor 92 can detect the change in tilt position (change in tilt angle) of the portable apparatus 1. As a result, the control module 100 can recognize that the user tries to operate the difficult-to-operate area. When the touch sensor 90 detects movement of the holding finger 32, and the tilt sensor 92 detects the change in tilt position of the portable apparatus 1, the control module 100 controls the display panel 120 so that contents displayed in the difficult-to-operate area are displayed in the easy-to-operate area. This is described in detail below with reference to a flowchart of FIG. 8.

FIG. 8 illustrates the flowchart showing an example of operation of the control module 100. First, in step S1, the touch sensor 90 detects movement of the holding finger 32, and the tilt sensor 92 detects the change in tilt position of the portable apparatus 1. Upon detection described above, processing in step S2 is performed. These two types of detection are performed in the same time period. This means that processing in step S2 is not performed if these types of detection are separately performed in different time periods relatively distant from each other.

Next, in step S2, the control module 100 changes a screen shown in the display area 2a as described in detail below.

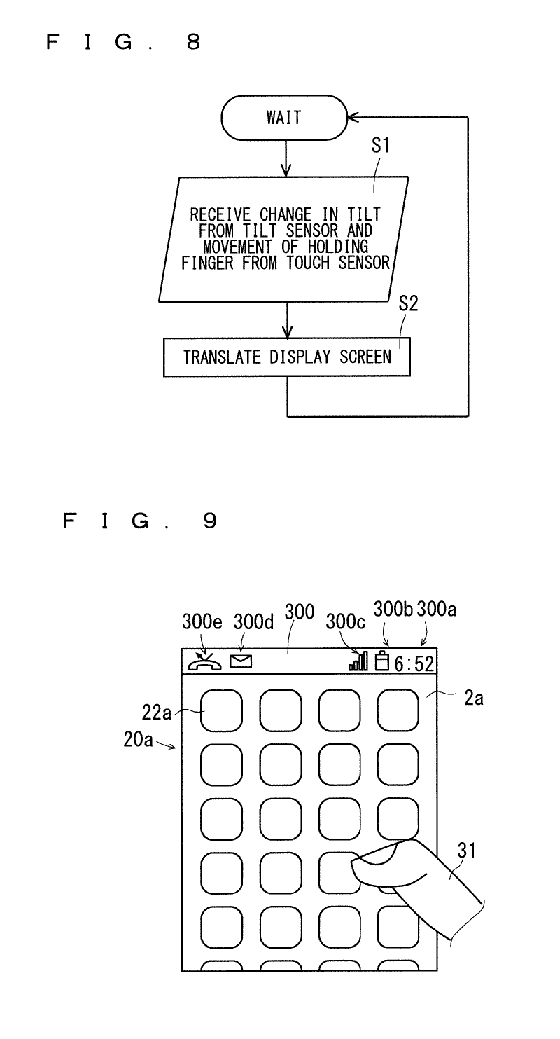

FIG. 9 illustrates an example of a display screen 20a having been displayed in the display area 2a. The display screen 20a is the home screen, for example. In the display screen 20a, a plurality of display signs (app icons) 22a are arranged, for example, in a matrix at intervals therebetween. The app icons 22a are used to select the applications 103b. For example, if the touch panel 130 detects the tap operation performed on a predetermined app icon 22a, the control module 100 judges that the app icon 22a has been selected, and runs one of the applications 103b corresponding to the app icon 22a.

In addition to the home screen, information indicating the state of the portable apparatus 1 is displayed in an upper end portion 300 of the display area 2a. In the example of FIG. 9, in the upper end portion 300 of the display area 2a, current time 300a measured by the portable apparatus 1, an icon (figure) 300b indicating the amount of remaining battery power, and an icon 300c indicating a communication state are displayed as the information indicating the state of the portable apparatus 1.

If a particular event occurs in the portable apparatus 1, information concerning the event is displayed in the upper end portion 300 of the display area 2a. If the occurrence of the particular event in the portable apparatus 1 is detected, the control module 100 controls the display panel 120 so that the information concerning the event is displayed in the display area 2a. In the example of FIG. 9, in the upper end portion 300 of the display area 2a, an icon 300d indicating the occurrence of an event of reception of a new email and an icon 300e indicating the occurrence of an event of a missed call are displayed as the information concerning the event occurring in the portable apparatus 1.

The screen displayed in the upper end portion 300 is also displayed in the other display screens described below, and thus description on the screen displayed in the upper end portion 300 is not repeated below.

In step S2, as illustrated in FIG. 10, the control module 100 translates the display screen 20a in a direction away from the contact location of the apparatus case 4 and the holding fingers 32, and displays the translated display screen 20a. The display screen 20a is herein translated (slid) towards the thumb 31 (to the lower right). In FIG. 10, a portion of the display screen 20a of FIG. 9 hidden through translation is shown in alternate long and two short dashes lines.

The control module 100 not only translates and displays the display screen 20a but also updates location information concerning operations. That is to say, the control module 100 sets the location information concerning operations performed on the display area 2a in accordance with the display screen 20a after translation. For example, portions (coordinates) where app icons 22a are displayed after translation are allocated to respective selection buttons for selecting applications 103b corresponding to the app icons 22a. As a result, if the tap operation is performed on an app icon 22a in the display screen 20a after translation, the control module 100 can properly run an application 103b corresponding to the app icon 22a on which the tap operation has been performed.

As described above, the portion of the display screen 20a having been displayed in the difficult-to-operate area (herein, the area in the upper left end portion) is displayed in the easy-to-operate area of the display area 2a. The user can thus easily operate the portion with the thumb 31 of the right hand 30.

Since a case where the user holds the portable apparatus 1 with the right hand 30 is described herein, the control module 100 translates the display screen 20a to the lower right towards the thumb 31 of the right hand 30. On the other hand, in a case where the portable apparatus 1 is held with the left hand 20, the display screen 20a is translated to the lower left so that an upper right end portion of the display screen 20a of FIG. 9 approaches the thumb 21 of the left hand 20.

The control module 100 can determine a direction of translation of the display screen 20a based on a direction of the change in tilt position of the portable apparatus 1 in step S2. This is because, in a case where the difficult-to-operate area is operated with the right hand 30, the portable apparatus 1 is tilted so that the upper left end portion thereof approaches the thumb 31 of the user (see FIG. 3), and, in a case where the difficult-to-operate area is operated with the left hand 20, the portable apparatus 1 is tilted so that an upper right end portion thereof approaches the thumb 21 of the user (see FIG. 4). That is to say, the direction of the change in tilt position of the portable apparatus 1 varies depending on the hand with which the portable apparatus 1 is held.

The control module 100 recognizes the direction of the change in tilt position of the portable apparatus 1 based on the change in value (tilt angle) detected by the tilt sensor 92 over time. The control module 100 determines a direction of translation of the display screen 20a based on the direction of the change in tilt angle of the portable apparatus 1. More specifically, if the tilt angle of the portable apparatus 1 changes so that the upper left end portion of the portable apparatus 1 approaches the user relative to the lower right end portion of the portable apparatus 1, the control module 100 translates the display screen 20a to the lower right as illustrated in FIG. 10. That is to say, when such a change in tilt angle is detected, the control module 100 judges that the portable apparatus 1 is held with the right hand 30, and translates the display screen 20a to the lower right.

If the tilt angle of the portable apparatus 1 changes so that the upper right end portion of the portable apparatus 1 approaches the user relative to a lower left end portion of the portable apparatus 1, the control module 100 translates the display screen 20a to the lower left. That is to say, when such a change in tilt angle is detected, the control module 100 judges that the portable apparatus 1 is held with the left hand 20, and translates the display screen 20a to the lower left. This means that the display screen 20a is translated towards a portion of the display area 2a moved relatively away from the user due to the tilt.

As described above, according to one embodiment, contents displayed in the difficult-to-operate area are automatically displayed in the easy-to-operate area when the user tries to operate the difficult-to-operate area. This facilitates operations performed on the display area 2a. Furthermore, even if the user knows nothing about this function, contents displayed in the difficult-to-operate area are displayed in the easy-to-operate area when the user only tries to operate the difficult-to-operate area. The user can thus use this function without having any special knowledge of operations, in other words, without reading a manual and the like.

<Determination on Whether Translation is Required Based on How Holding Fingers Move>

An event involving movement of the holding fingers and the change in tilt position of the portable apparatus 1 can occur in cases other than the case where the user tries to operate the difficult-to-operate area. For example, the holding fingers can move, and the tilt position of the portable apparatus 1 can change in the case of changing the holding position of the portable apparatus 1, or in the case of changing the hand with which the portable apparatus 1 is held. The aim herein is to more accurately detect the fact that the user tries to operate the difficult-to-operate area by focusing on how the holding fingers move.

When the user tries to operate the difficult-to-operate area, the holding fingers move from the front face to the back face as described above, for example. In this case, the value detected by the touch sensor 90 changes as shown in FIG. 7, for example.

The control module 100 thus determines how the holding fingers move (i.e., a direction of the change in contact location of the holding fingers) based on the change in detected value at locations in the touch sensor 90 over time. The control module 100 translates the display screen 20a if the direction of the change in contact location of the holding fingers as detected matches a direction (e.g., direction from the front face to the back face) determined in advance as the direction of the change when the difficult-to-operate area is tried to be operated. The direction determined in advance is stored, for example, in the storage module 103.

As a result, the fact that the user tries to operate the difficult-to-operate area can more accurately be detected. In other words, unnecessary translation of the display screen 20a can be suppressed.

When the user tries to operate the difficult-to-operate area, the holding fingers can move downwards along the side face of the portable apparatus 1. A condition that the holding fingers move downwards may be used. That is to say, the display screen may be translated if downward movement of the holding fingers and the change in tilt position of the portable apparatus 1 are detected. In short, the display screen 20a is translated if movement of the holding fingers when the user tries to operate the difficult-to-operate area and the change in tilt position are detected.

<Determination on Whether Translation is Required Based on Amount of Change in Tilt Angle>

The amount of change in tilt angle of the portable apparatus 1 when the user tries to operate the difficult-to-operate area varies among individuals, but the amount of change is not so large. An average amount of change is about 20 degrees, for example. Whether the user tries to operate the difficult-to-operate area or the user simply tries to change the holding position or to change the hand with which the portable apparatus 1 is held may be determined based on the amount of change in tilt angle.

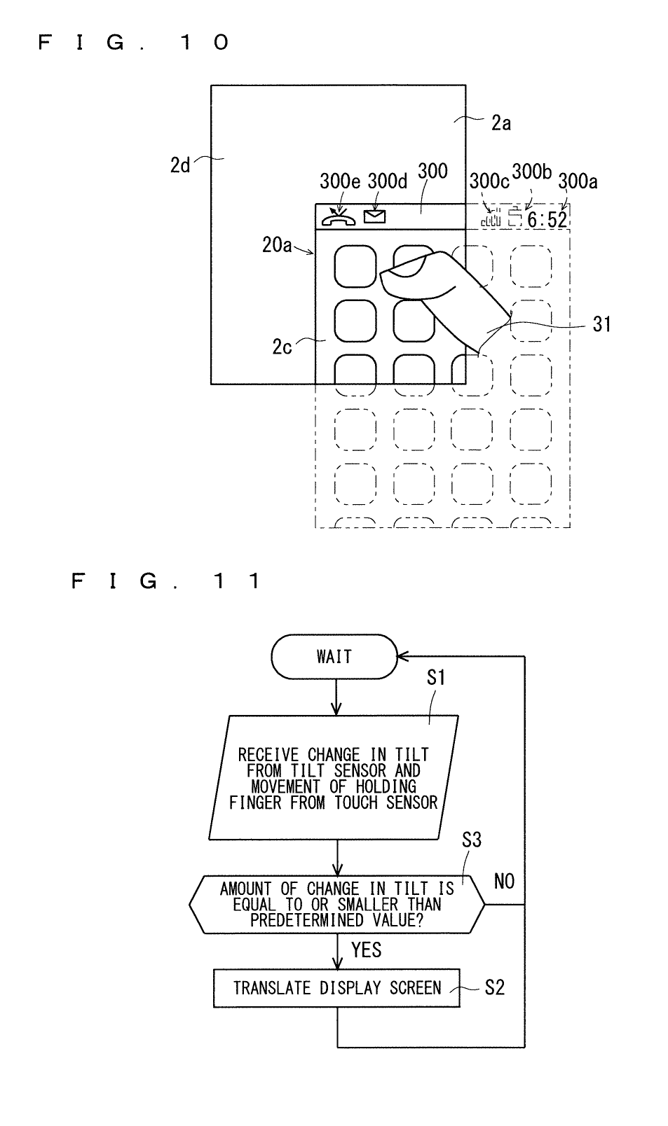

FIG. 11 illustrates a flowchart showing an example of operation of the control module 100. Compared to operation shown in FIG. 8, processing in step S3 has been added. Processing in step S3 is performed between processing in step S1 and processing in step S2. In step S3, the control module 100 judges whether the amount of change in tilt angle of the portable apparatus 1 is equal to or smaller than a predetermined value (e.g., 20 degrees). If an affirmative judgment is made, the control module 100 performs processing in step S2. If a negative judgment is made, the control module 100 waits without performing processing in step S2.

That is to say, in a case where the amount of change in tilt angle of the portable apparatus 1 is smaller than the predetermined value, the control module 100 judges that the user tries to operate the difficult-to-operate area, and translates the display screen 20a. On the other hand, in a case where the amount of change in tilt angle is larger than the predetermined value, the control module 100 judges that the user does not try to operate the difficult-to-operate area, and does not perform processing in step S2. As a result, unnecessary translation of the display screen 20a can be reduced.

Alternatively, processing in step S3 may be performed after processing in step S2, and, if a negative judgment is made in step S3, the control module 100 may display the display screen 20a in the display area 2a as a whole. That is to say, the display screen 20a is once translated and displayed upon processing in step S1, but, if the amount of change in tilt angle exceeds the predetermined value, it is judged that the user does not try to operate the difficult-to-operate area, and the display is returned to the original state. The amount of change in tilt angle herein refers to the amount of change in tilt angle of the portable apparatus 1 made in the same time period as movement of the holding fingers, and is the amount of change from a start time point of the change in tilt angle in step S1 to the end of the change, for example.

<Determination of Direction of Movement of Display Screen>

In the above-mentioned example, the tilt sensor 92 detects the direction of the change in tilt angle, and, based on the results of detection, the direction of movement of the display screen 20a is determined. The direction of translation is herein determined based on information concerning which of the touch sensors 90 located on opposite side faces of the apparatus case 4 has detected movement of the holding fingers.

In a case where the portable apparatus 1 is held with the right hand 30, in FIG. 3, the touch sensor 90 on the left side of the plane of FIG. 3 detects movement of the holding fingers 32. Thus, if the touch sensor 90 on the left side has detected movement of the holding fingers 32, the control module 100 translates the display screen 20a to the lower right. On the other hand, if the touch sensor 90 on the right side has detected movement of the holding fingers 22, the control module 100 judges that the portable apparatus 1 is held with the left hand 20 (see FIG. 4), and translates the display screen 20a to the lower left.

That is to say, the display screen 20a is translated downwards and towards a side face different from the side face on which the touch sensor 90 having detected movement of the holding fingers is located. This eliminates the need for the control module 100 to calculate the direction of the change in detected value to determine the direction of translation of the display screen 20a. As a result, processing is simplified.

When the tilt position of the portable apparatus 1 changes, the contact location of the touch sensor 90 and the base of the thumb can change. The change in contact location of the base of the thumb, however, is smaller than the change in contact location of the holding fingers. Therefore, by adjusting a threshold for detecting movement of the holding fingers, false detection of the change in contact location of the base of the thumb as movement of the holding fingers can be suppressed or avoided.

<Location of Touch Sensor>

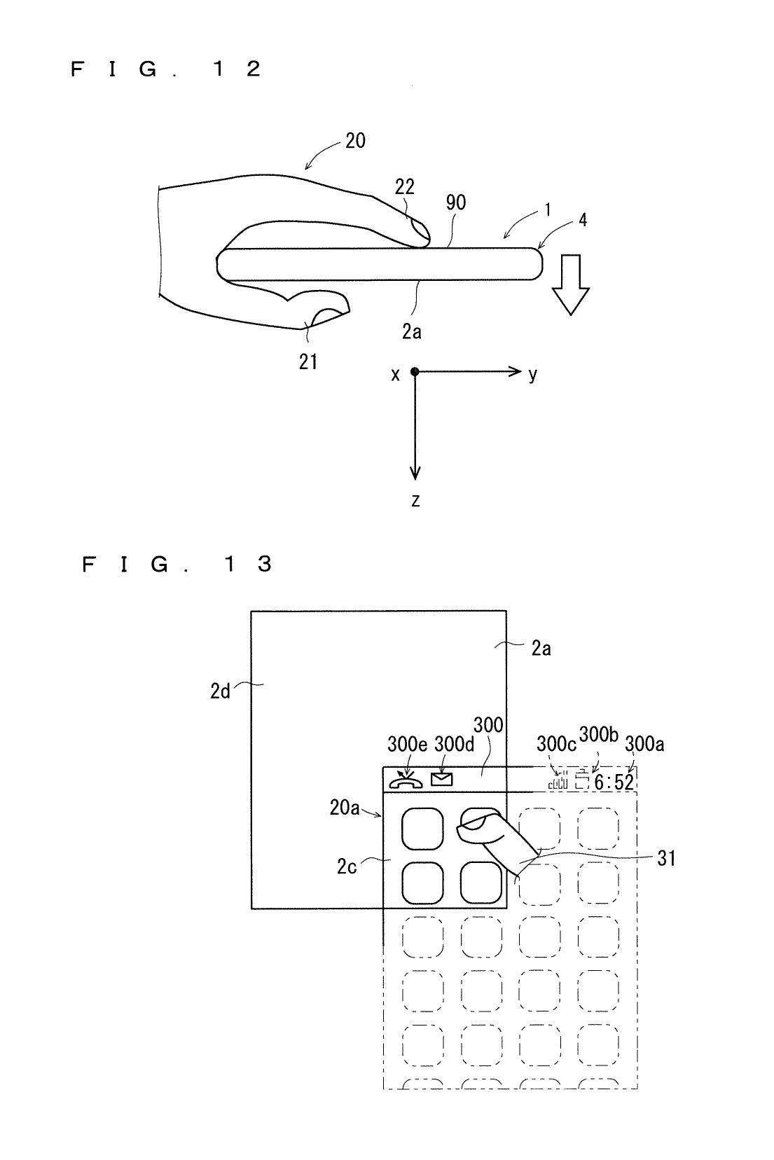

In the above-mentioned example, the touch sensors 90 are located on the opposite side faces of the apparatus case 4. However, there is a case where the portable apparatus 1 cannot be held by being sandwiched from the side faces thereof with one hand. For example, in a case where the portable apparatus 1 of FIG. 3 is held horizontally (i.e., the portable apparatus 1 of FIG. 3 is rotated 90 degrees, and held), or in a case where the length and the width of the portable apparatus 1 are large, the portable apparatus 1 cannot be held by being sandwiched from the side faces thereof with one hand. In this case, as illustrated in FIG. 12, the user brings the base of the thumb into contact with a side face of the portable apparatus 1, and brings the holding fingers into contact with the back face of the portable apparatus 1 to hold the portable apparatus 1. The touch sensor 90 for detecting movement of the holding fingers is thus located on the back face of the apparatus case 4 in this case. FIG. 12 illustrates a case where the portable apparatus 1 is held with the left hand 20.

As described above, in a case where the holding fingers 22 of the left hand 20 are brought into contact with the back face of the apparatus case 4, the user tries to operate the difficult-to-operate area (an end portion of the display area 2a on the right side of the plane of FIG. 12) as follows, for example. That is to say, the user stretches the thumb 21 to the difficult-to-operate area while pushing the back face of the portable apparatus 1 by bending the holding fingers 22. With this operation, the holding fingers 22 move along the back face towards the base of the thumb 21 (to the left in the plane of FIG. 12).

If the touch sensor 90 detects movement of the holding fingers 22, and the tilt sensor 92 detects the change in tilt angle of the portable apparatus 1, the control module 100 translates the display screen 20a towards the thumb 21, and displays the display screen 20a.

The direction of translation is determined based on the direction of the change in tilt angle detected by the tilt sensor 92. For example, in FIG. 12, the portable apparatus 1 is tilted so that the end portion on the right side of the plane of FIG. 12 approaches the user relative to an end portion on the left side of the plane of FIG. 12. Thus, if the tilt sensor 92 detects the change in this direction, the control module 100 translates the display screen 20a to the left in the plane of FIG. 12. On the other hand, if the fact that the portable apparatus 1 is tilted so that the end portion on the left side of the plane of FIG. 12 approaches the user relative to the end portion on the right side of the plane of FIG. 12 is detected, the control module 100 judges that the portable apparatus 1 is held with the right hand 30, and translates the display screen 20a to the right in the plane of FIG. 12. That is to say, the display screen 20a is translated towards a portion moved relatively away from the user due to the tilt.

As a result, when the user only tries to operate the difficult-to-operate area, contents displayed in the difficult-to-operate area are displayed in the easy-to-operate area. Even in a case where the holding fingers are in contact with the back face of the portable apparatus 1, operations can be facilitated as described above.

The direction of translation may be determined based on how the holding fingers move. That is to say, the holding fingers 22 move to the left in the plane of FIG. 12 in a case where the portable apparatus 1 is held with the left hand 20. Upon detection of movement in this direction performed by the touch sensor 90, the control module 100 may translate the display screen 20a to the left in the plane of FIG. 12. On the other hand, if movement of the holding fingers 22 to the right in the plane of FIG. 12 is detected, the control module 100 judges that the portable apparatus 1 is held with the right hand 30, and translates the display screen 20a to the right in the plane of FIG. 12. That is to say, the display screen 20a is translated in the direction of movement of the contact location of the holding fingers.

<Amount of Translation>

The size of the hand varies among individuals, and a user with large hands can operate the difficult-to-operate area without tilting the portable apparatus 1 so much. On the other hand, a user with small hands is required to significantly tilt the portable apparatus 1.

The control module 100 may thus increase the amount of translation as the amount of change in tilt angle increases. That is to say, for the user with small hands, the control module 100 moves the portion of the display screen 20a displayed in the difficult-to-operate area closer to the operating finger, and displays the moved portion. FIG. 13 illustrates the display area 2a after translation in a case where the amount of change in tilt angle is large. An area 2c of the display area 2a in which the display screen 20a is displayed after translation has a smaller size than that illustrated in FIG. 10. As a result, for a user with a shorter operating finger 31, the display screen 20a is displayed in an area closer to the operating finger. The user can thus easily operate the area.

On the other hand, for the user with large hands, the amount of translation is relatively small as the amount of change in tilt angle is relatively small. The area 2c in which the display screen 20a is displayed after translation thus has a relatively large size. It is rather difficult to operate an area of the display area 2a that is too close to the base of the operating finger with the operating finger. Thus, for a person with large hands, the display screen 20a is displayed so as to be relatively large to display contents of the display screen 20a in an area relatively distant from the base of the operating finger.

As described above, the size of the area in which the display screen 20a is displayed can properly be set in accordance with the size of the hand.

<Reduction of Display Screen>

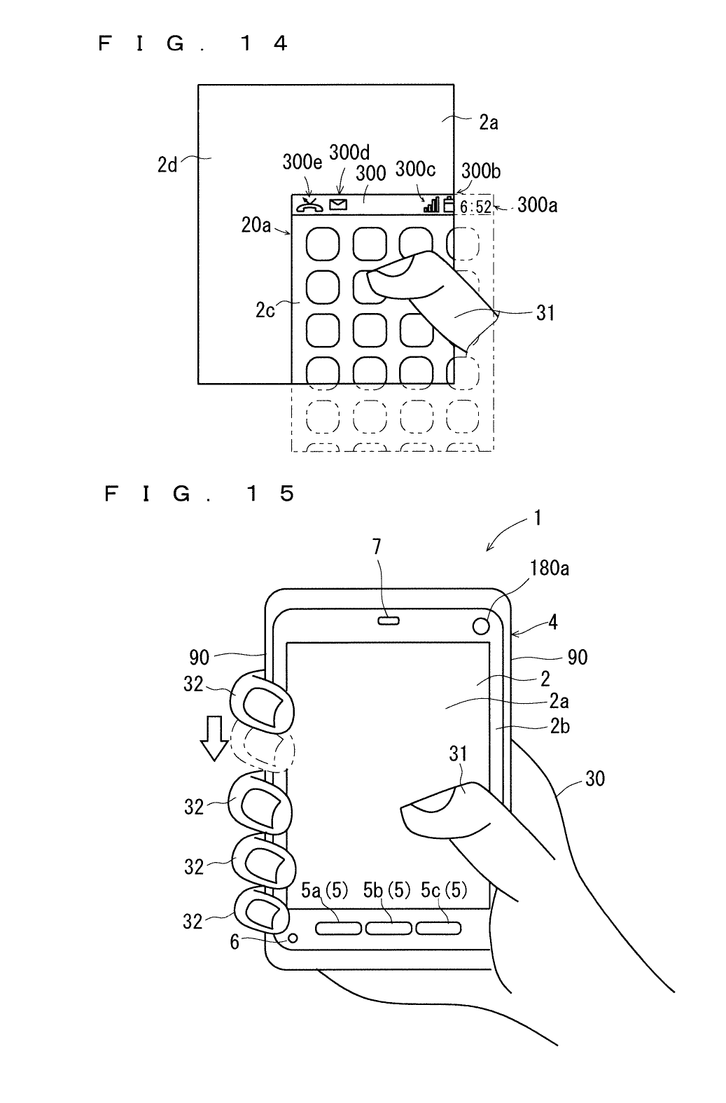

The control module 100 may reduce and display the display screen 20a while translating the display screen 20a. The target for reduction is herein not the size of the area 2c in which the display screen 20a is displayed after translation but the scale of the display screen 20a. FIG. 14 illustrates the display screen 20a having been translated while being reduced. As illustrated in FIG. 14, app icons 22a included in the display screen 20a are displayed such that the app icons 22a each have a smaller size than those illustrated in FIG. 10, and the distance between the app icons 22a is shorter than that illustrated in FIG. 10. More app icons 22a can thus be displayed after translation. In other words, the amount of information that can be displayed on the display screen 20a can be increased.

On the other hand, the display screen 20a may be displayed without being reduced as illustrated in FIG. 10 described above. This is because reduction of the display screen 20a can make it difficult to operate the display screen 20a. For example, reduction of the display screen 20a leads to reduction of the app icons 22a and reduction in distance between the app icons 22a. This may make it difficult to select a desired app icon 22a. The display screen 20a may be displayed without being reduced to avoid such a problem.

<Return Display to Original State>

If the touch sensor 90 detects the change in contact location of the holding fingers as a predetermined operation in a case where the display screen 20a is translated and displayed in a portion (the area 2c) of the display area 2a, the control module 100 displays the display screen 20a in the display area 2a as a whole. An example of the predetermined operation includes, with reference to FIG. 15, an operation to move a holding finger 32 in a predetermined direction (e.g., downwards in the plane of FIG. 15) with the holding finger 32 in contact with the touch sensor 90. In FIG. 15, the holding finger 32 after movement is illustrated in alternate long and two short dashes lines. As a result, display can be returned to an original state with a simple operation.

<Display Screen Displayed in Display Area 2a>

<Display of Two Display Screens>

As described above, the control module 100 translates the display screen 20a, and displays the translated display screen 20a in the display area 2a, so that a portion of the display screen 20a is displayed in a portion (the area 2c) of the display area 2a. Hereinafter, the area 2c of the display area 2a in which the portion of the display screen 20a is displayed after translation is referred to as a main area 2c, and the other area is referred to as a sub area 2d (see also FIG. 10). The main area 2c is approximately rectangular in a plan view, for example, and the sub area 2d has a shape obtained by cutting the main area 2c out of the display area 2a.

In view of the demand regarding portable apparatuses for improvement in the amount of information included in the display screen, the aim below is to provide display technology enabling improvement in the amount of information.

In the above-mentioned example, the control module 100 translates and displays the display screen 20a if the touch sensor 90 detects movement of the holding fingers, and the tilt sensor 92 detects the change in tilt position of the portable apparatus 1. In the following description, however, the condition (trigger) for translating the display screen 20a is not limited to that described above. The condition (trigger) for translating the display screen 20a may appropriately be changed.

For example, an input module (a hard key or a soft key) for translating the display screen 20a may be provided on the portable apparatus 1, and the display screen 20a may be translated based on an input by the user into the input module. As for the direction of translation, an input module for inputting the direction of translation may be provided. With such configuration, the touch sensor 90 and the tilt sensor 92 are not essential components.

The touch sensor 90 may function as the input module. That is to say, a particular operation may be performed on the touch sensor 90 to cause the control module 100 to translate the display screen 20a. An example of the particular operation includes an operation to bring a finger into contact with the touch sensor 90, and release the finger after a predetermined time period. The direction of translation of the display screen 20a may also be input into the portable apparatus 1 through the touch sensor 90. For example, the direction of translation of the display screen 20a can be input based on which of the touch sensors 90 located on the opposite side faces has received the operation. As described above, in a case where the touch sensor 90 functions as the input module, the tilt sensor 92 is not an essential component.

In step S2, the control module 100 translates the display screen 20a and displays the portion of the display screen 20a in the main area 2c, and displays a display screen other than the display screen 20a in the sub area 2d. An example of the other display screen includes a display screen of one of the applications 103b that is run when processing in step S2 is performed. Alternatively, a predetermined one of the applications 103b may be run, and a display screen of the predetermined application 103b may be displayed as the other display screen.

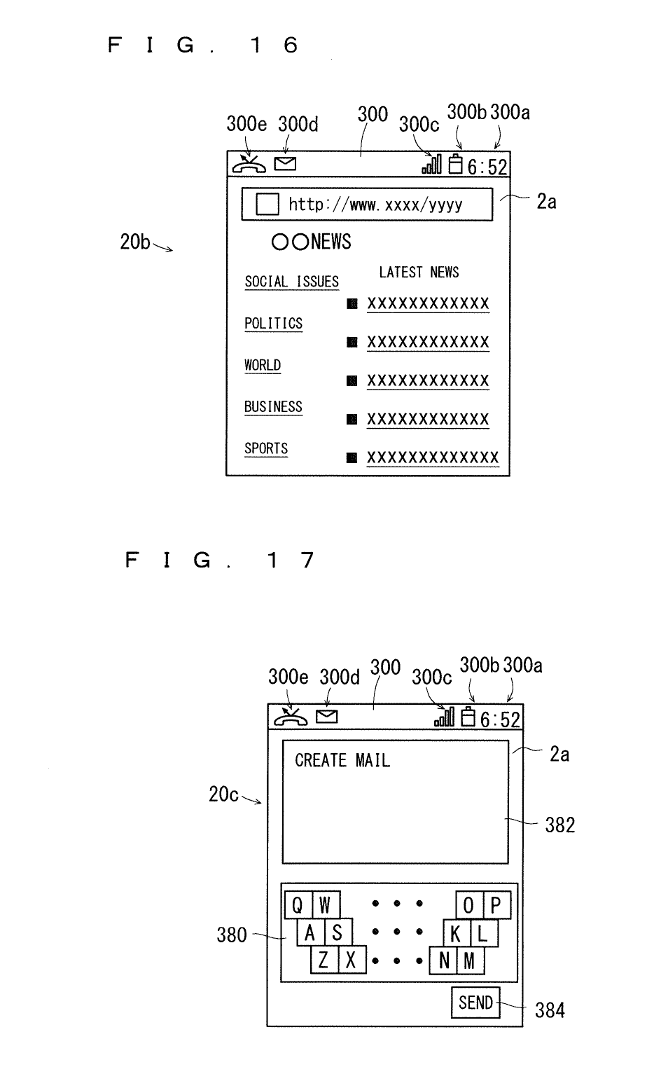

FIGS. 16 to 18 schematically illustrate display screens displayed when the applications 103b are run. FIG. 16 schematically illustrates an example of a display screen 20b displayed when a web browser is run, and a web page indicating news information is displayed in the display area 2a. The web page includes a plurality of links (hyperlinks). In FIG. 16, the links included in the web page are underlined. The control module 100, which runs the web browser stored in the storage module 103, acquires the web page from a web server through the wireless communication module 110, and then controls the display panel 120 so that the web page 50 is displayed in the display area 2a.

If the touch panel 130 detects a tap operation performed on a portion of the display area 2a in which a link included in the web page is displayed, the control module 100 judges that the link has been selected by the user. The control module 100 then performs communication with the web server through the wireless communication module 110 to acquire a web page indicated by the link from the web server. The display panel 120 displays the web page acquired by the control module 100 in the display area 2a through control by the control module 100.

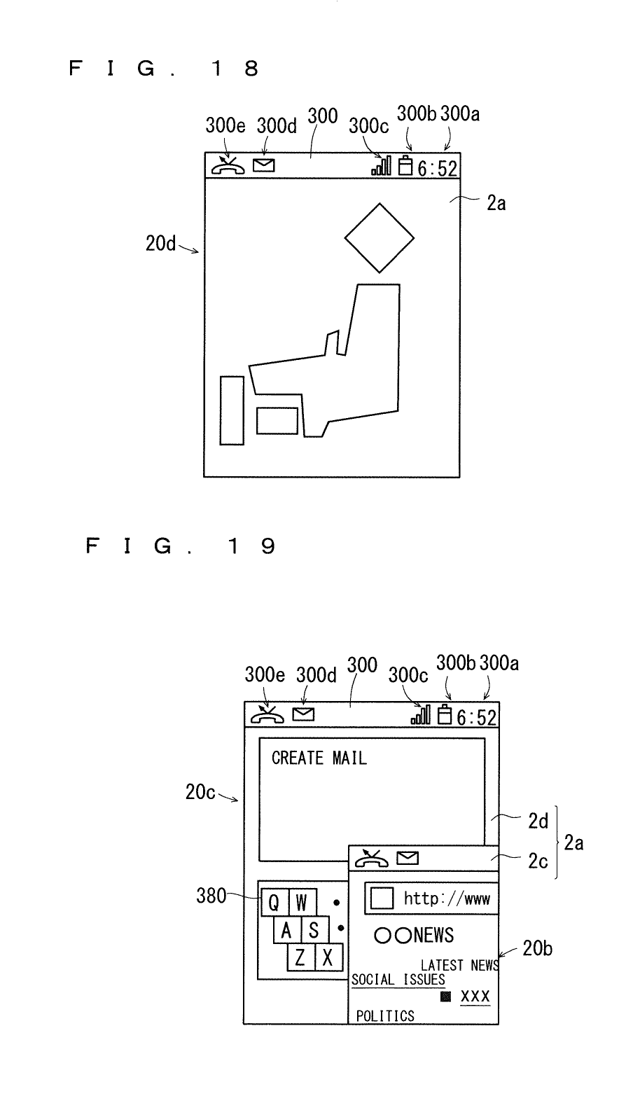

FIG. 17 schematically illustrates an example of a display screen 20c displayed when a mail application is run, and a screen for creating a text to be sent is displayed in the display area 2a. The display screen 20c is stored in the storage module 103, and the control module 100 reads the display screen 20c from the storage module 103, and controls the display panel 120 so that the display screen 20c is displayed in the display area 2a. In the example of FIG. 17, an area 382 for displaying the text to be sent, character input buttons 380 for inputting the text to be sent, and a send button 384 for sending the text to be sent are displayed in the display area 2a.

If the touch panel 130 detects an operation performed on a portion including one of the character input buttons 380, the control module 100 displays a character corresponding to the operation performed on the character input button 380 in the area 382. If the touch panel 130 detects an operation performed on a portion including the send button 384, the control module 100 sends the text to be sent displayed in the area 382 to a destination terminal through the wireless communication module 110.

FIG. 18 schematically illustrates an example of a display screen 20d displayed when a map application for viewing a map is run, and a screen showing a map of Japan is displayed in the display area 2a. The display screen 20d is stored in the web server, for example, and the control module 100 acquires the display screen 20d through the wireless communication module 110, and then controls the display panel 120 so that the display screen 20d is displayed in the display area 2a.

If the touch panel 130 detects a slide operation performed on a portion including the display screen 20d, the control module 100 scrolls the map in a direction of the slide operation, and displays the scrolled map in the display area 2a. If the touch panel 130 detects a pinch-in operation performed on the display screen 20d, the control module 100 reduces the scale (i.e., increases the denominator of the scale) in accordance with the distance between two operators, and displays the map. If the touch panel 130 detects a pinch-out operation, the control module 100 increases the scale in accordance with the distance between two operators, and displays the map.

Assume that the three applications 103b (web browser, mail application, and map application) illustrated in FIGS. 16 to 18 are run, and the display screen 20c of the web server is displayed in the display area 2a (FIG. 16). The current display screen 20c of the mail application and the current display screen 20d of the map application are stored by the control module 100 in the storage module 103, for example, and are not displayed in the display area 2a in this stage.

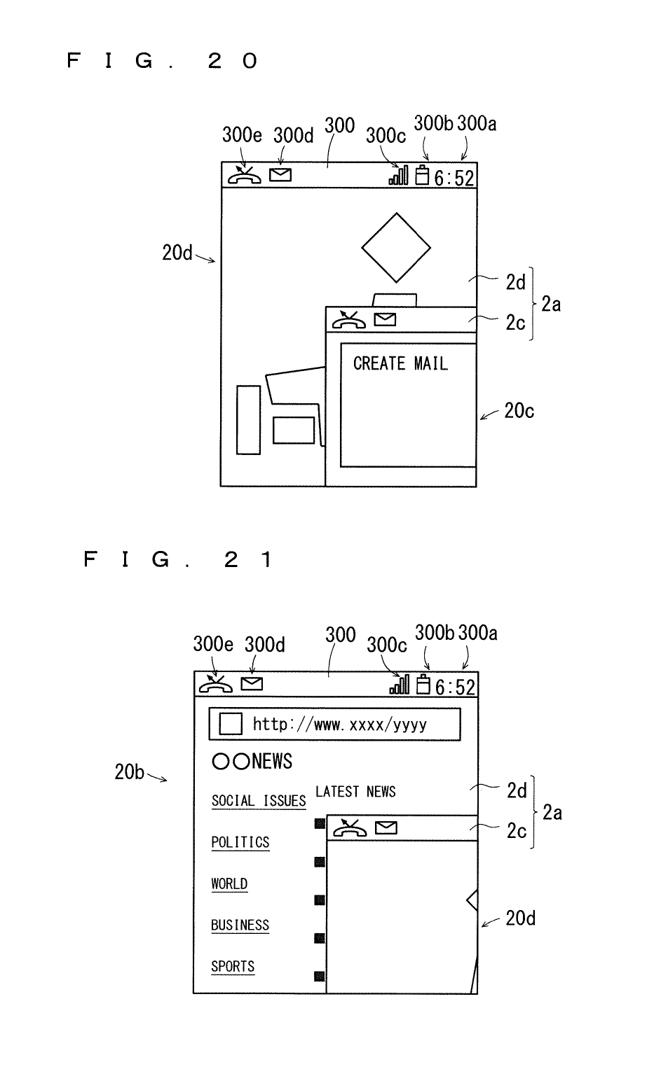

In this state, the control module 100 translates the display screen 20b, and displays the translated display screen 20b in the main area 2c (see FIG. 19). At the same time, the control module 100 displays, for example, the display screen 20c of the mail application in the sub area 2d. In the example of FIG. 19, the main area 2c is a lower right rectangular area of the display area 2a, and an upper left end portion of the display screen 20b of FIG. 16 is displayed in the main area 2c. The sub area 2d has a shape obtained by cutting the main area 2c out of the display area 2a, and thus a portion of the display screen 20c of FIG. 17 corresponding to the main area 2c is hidden in FIG. 19. That is to say, the display screen 20b in the main area 2c is displayed so as to overlap the display screen 20c in the sub area 2d.

This allows the user to view not only the display screen 20b but also other information (i.e., the display screen 20c). As a result, the amount of information obtained from the display area 2a can be improved.

<Switching of Display Screens in Main Area and in Sub Area>

If the touch panel 130 detects a predetermined first operation (herein, a slide operation) performed on the display area 2a, for example, in a case where the main area 2c and the sub area 2d are displayed, the control module 100 recognizes the first operation as an operation to switch display screens in the main area 2c and in the sub area 2d. That is to say, the control module 100 restricts the function (function of the control module 100 running the application 103b, hereinafter, the same applies) of the application 103b to be achieved by the first operation. For example, in FIG. 18, if the slide operation is performed on the display screen 20d in which the map application is displayed, the control module 100 running the map application scrolls and displays the map. In a case where the main area 2c and the sub area 2d are displayed, however, the control module 100 may not allow the function (scroll display) to be achieved by the first operation to be achieved.

On the other hand, the control module 100 recognizes the first operation as the operation to switch the display screens in the main area 2c and in the sub area 2d. That is to say, if the first operation performed on the display area 2a is detected, the control module 100 controls the display panel 120 so that the display screens in the main area 2c and in the sub area 2d are switched to other display screens. For example, as illustrated in FIG. 20, the control module 100 displays, in the main area 2c, the display screen 20c displayed in the sub area 2d in FIG. 19, and displays, in the sub area 2d, the display screen 20d of the map application.

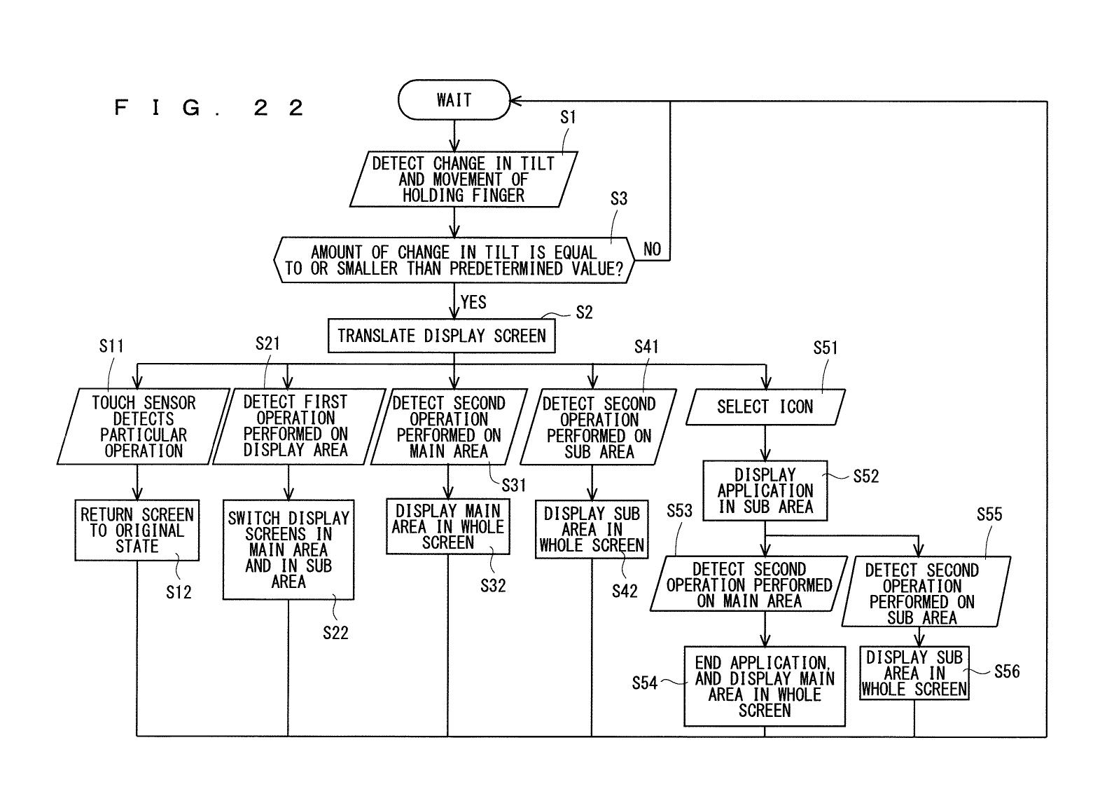

If the touch panel 130 detects the first operation again in this state, the control module 100 switches the display screens in the main area 2c and in the sub area 2d to other display screens again. For example, as illustrated in FIG. 21, the control module 100 displays, in the main area 2c, the display screen 20d displayed in the sub area 2d in FIG. 20, and displays the display screen 20b in the sub area 2d. Switching is hereinafter repeated in the above-mentioned order upon the first operation.

According to such switching operation, display screens of applications 103b currently being run are sequentially displayed in the main area 2c and in the sub area 2d. As a result, the user can easily check the applications 103b currently being run by repeatedly performing the first operation.

The display screen to be displayed in the main area 2c after switching is displayed in the sub area 2d before switching. As a result, the user can switch the screen while knowing the screen to be displayed in the main area 2c next beforehand.

Although description is made herein using the three display screens 20b to 20d, two display screens or four or more display screens may be used. The display screen 20a may be used.

Switching of the display screens in the main area 2c and in the sub area 2d is herein performed upon the first operation performed on the display area 2a. Switching of the display screens, however, is not limited to that described above in one embodiment. The control module 100 may perform switching upon an input into another input module (a hard key or a soft key). In other words, the control module 100 may perform switching upon an input by the user into the detection module 132.

In a case where the touch sensor 90 is provided, for example, switching may be performed upon an operation performed on the touch sensor 90. In the case of using an input module other than the touch panel 130 as described above, the control module 100 is not required to impose the above-mentioned restriction on operations performed on the main area 2c and the sub area 2d. That is to say, the control module 100 may determine various operations performed on the main area 2c and the sub area 2d as operations performed on the applications 103b displayed in the main area 2c and the sub area 2d.

<Switching between Overall Display and Display in Main Area and in Sub Area>

In a case where the touch panel 130 detects a predetermined second operation (an operation different from the first operation, for example, a double-tap operation) performed on the main area 2c, the control module 100 also restricts the function of the application 103b displayed in the main area 2c to be achieved by the second operation. Instead, the control module 100 performs the following control by the second operation. That is to say, if the second operation performed on the main area 2c is detected, the control module 100 controls the display panel 120 so that the display screen displayed in the main area 2c is displayed in the display area 2a as a whole. For example, in the display area 2a illustrated in FIG. 21, if the second operation is performed on the main area 2c, the display screen 20d in the main area 2c is displayed in the display area 2a as a whole (see FIG. 18). That is to say, the main area 2c and the sub area 2d disappear, and display of the display screen 20b in the sub area 2d in FIG. 21 ends.

In FIG. 21, if the second operation performed on the sub area 2d is detected, the control module 100 displays the display screen 20b displayed in the sub area 2d in the display area 2a as a whole (see FIG. 16). As a result, the main area 2c and the sub area 2d disappear, and display of the display screen 20d in the main area 2c in FIG. 21 ends.

The control module 100 further cancels the above-mentioned restriction on the function to be achieved by the operation performed on the display area 2a. This allows the user to achieve the function of the application 103b displayed in the display area 2a as a whole by the first operation and the second operation.

According to such a switching method, one of the main area 2c and the sub area 2d is displayed in the display area 2a as a whole in response to an operation performed on each of the main area 2c and the sub area 2d, and thus the user can easily understand the operation.

In the above-mentioned example, one of the main area 2c and the sub area 2d is displayed in the display area 2a as a whole upon the second operation performed on the main area 2c and the sub area 2d. Display control, however, is not limited to that described above, and may be performed upon an operation performed on another input module. In other words, the control module 100 may perform display in the display area 2a as a whole upon an input by the user into the detection module 132. However, an operation different from the above-mentioned operation to switch the screens in the main area 2c and in the sub area 2d is used.

In a case where the touch sensor 90 is provided, for example, switching may be performed upon an operation performed on the touch sensor 90. That is to say, switching may be performed if the touch sensor 90 detects, as the operation, a predetermined change (e.g., a change made when the operating finger moves in one direction while being in contact with the touch sensor 90) in contact location of the holding finger. In this case, information concerning whether the display screen in the main area 2c is displayed in the display area 2a as a whole or the display screen in the sub area 2d is displayed in the display area 2a as a whole may be input into the portable apparatus 1 through the operation performed on the touch sensor 90. For example, this information may be input based on which of the touch sensors 90 located on the opposite side faces has received the operation.

In the case of using an input module other than the touch panel 130 as described above, the control module 100 is not required to impose the above-mentioned restriction on operations performed on the main area 2c and the sub area 2d. That is to say, the control module 100 may determine various operations performed on the main area 2c and the sub area 2d as operations performed on the applications 103b displayed in the main area 2c and the sub area 2d.

<Display Screen in Sub Area>

Assumed next is a case where the display screen (selection screen) 20a showing the app icons 22a is displayed in the main area 2c. In this case, if the touch panel 130 detects an operation (e.g., a tap operation) to select one of the app icons 22a, the control module 100 may run an application corresponding to the selected app icon 22a, and display a display screen of the application in the sub area 2d. As a result, the application being run can be viewed in the sub area 2d while the display screen 20a is displayed in the main area 2c. With this configuration, even if a wrong app icon 22a is selected, another app icon 22a can immediately be selected as the display screen 20a is displayed in the main area 2c, which is easily operated.

If the operation to display the display screen in the main area 2c in the display area 2a as a whole is detected in this state, the control module 100 may end the application 103b displayed in the sub area 2d while displaying the display screen in the main area 2c in the display area 2a as a whole. As a result, the application 103b can easily be ended compared to a case where an operation to end the application 103b is separately performed.

<Example of Operation of Control Module>

FIG. 22 illustrates a flowchart showing an example of operation of the control module. FIG. 22 appropriately incorporates therein the above-mentioned control. Detailed description is given below.

Processing in steps S1 and S3 is the same as that described above, and thus description thereof is not repeated. In step S2, the control module 100 translates the display screen and displays the translated display screen in the main area 2c, and also displays the display screen of the application 103b in the sub area 2d.

After processing in step S2 is performed, in step S11, the touch sensor 90 detects a particular operation (e.g., an operation to move the operating finger in one direction with the operating finger in contact with the touch sensor 90). Upon detection described above, in step S12, the control module 100 displays contents displayed in the main area 2c in the display area 2a as a whole, and waits.

After processing in step S2 is performed, in step S21, the touch panel 130 detects the first operation performed on the display area 2a. Upon detection described above, in step S22, the control module 100 switches contents displayed in the main area 2c and in the sub area 2d as described above, and waits.

After processing in step S2 is performed, in step S31, the touch panel 130 detects the second operation performed on the main area 2c. Upon detection described above, in step S32, the control module 100 displays the contents displayed in the main area 2c in the display area 2a as a whole.

After processing in step S2 is performed, in step S41, the touch panel 130 detects the second operation performed on the sub area 2d. Upon detection described above, in step S42, the control module 100 displays the contents displayed in the sub area 2d in the display area 2a as a whole.

After processing in step S2 is performed, in step S51, the touch panel 130 detects the operation (e.g., tap operation) to select one of the app icons 22a displayed in the main area 2c. Processing in step S51 is performed when the control module 100 displays the home screen in step S2. Upon detection described above, in step S52, the control module 100 runs one of the applications 103b corresponding to the selected app icon 22a, and displays the display screen of the application 103b in the sub area 2d.

In this state, in step S53, the touch panel 130 detects the second operation performed on the main area 2c. Upon detection described above, in step S54, the control module 100 ends the application 103b displayed in the sub area 2d, and displays the display screen displayed in the main area 2c in the display area 2a as a whole.

If the touch panel 130 detects the second operation performed on the sub area 2d in step S55 after step S52, the control module 100 displays, upon detection described above, the display screen displayed in the sub area 2d in the display area 2a as a whole in step S56.

<Other Modifications>

Although a case where the present disclosure is applied to a portable telephone has been described in the above-mentioned example, the present disclosure is applicable to portable apparatuses other than the portable telephone.

While the present disclosure has been described in detail, the foregoing description is in all aspects illustrative and not restrictive. It is therefore understood that numerous modifications that have not been described can be devised without departing from the scope of the present disclosure. Various embodiments and modifications described above may be combined with one another unless any contradiction occurs. Numerous modifications that have not been described can be devised without departing from the scope of the present disclosure.

1. A portable apparatus comprising:
a housing;
a display area located on a front face of the housing;
an operation detection module configured to detect an operation performed with an operating finger on the display area;
at least one first detection module configured to detect a contact location of a holding finger holding the housing;
a second detection module configured to detect a tilt angle of the housing with respect to a reference position of the housing; and
at least one processor configured to translate, if the processor detects a change in the contact location, and the second detection module detects a change in the tilt angle of the housing, a display screen in a direction away from the contact location, and display the display screen in the display area.

2. The portable apparatus according to claim 1, wherein
the at least one processor translates the display screen, and displays the display screen in the display area if the change in the contact location is a change determined in advance as a change in the contact location when a user tries to operate a portion of the display area closer to the contact location.

3. The portable apparatus according to claim 1, wherein
the at least one processor translates the display screen, and displays the display screen in the display area if the amount of change in the tilt angle of the housing is equal to or smaller than a predetermined value.

4. The portable apparatus according to claim 1, wherein
the at least one processor determines a direction of translation of the display screen based on a direction of the change in the tilt angle of the housing.

5. The portable apparatus according to claim 1, wherein
the at least one first detection module comprises a plurality of first detection modules disposed on opposite side faces of the housing, and
the at least one processor determines a direction of translation of the display screen based on which of the first detection modules has detected movement of the holding finger.

6. The portable apparatus according to claim 1, wherein
the at least one first detection module comprises a first detection module disposed on a back face of the housing, and
the at least one processor determines a direction of translation of the display screen based on a direction of the change in the contact location on the back face of the housing.

7. The portable apparatus according to claim 1, wherein
if the processor detects the change in the contact location as a predetermined operation while the display screen is translated and displayed in a portion of the display area, the at least one processor displays the display screen in the display area as a whole.

8. The portable apparatus according to claim 1, wherein
the at least one processor translates and displays the display screen without reducing the display screen.

9. A portable apparatus comprising:
a housing;
a display area located on a front face of the housing;
a storage module configured to store a plurality of application programs;
a detection module configured to detect an input by a user; and
at least one processor configured to display a portion of a first display screen in a main area being a portion of the display area, and display a portion of a second display screen in a sub area being a portion of the display area other than the main area, the first display screen being displayed in the display area when a first application program is run, the second display screen being displayed in the display area when a second application program different from the first application program is run.

10. The portable apparatus according to claim 9, wherein
if the detection module detects a first input by the user in a case where the portion of the first display screen is displayed in the main area, and the portion of the second display screen is displayed in the sub area, the at least one processor displays a portion of the first display screen in the sub area, and displays a portion of the second display screen in the main area.

11. The portable apparatus according to claim 9, wherein
if the detection module detects a first input by the user in a case where the portion of the first display screen is displayed in the main area, and the portion of the second display screen is displayed in the sub area, the at least one processor displays a portion of the first display screen in the sub area, and displays a portion of a third display screen or a portion of a selection screen in the main area, the third display screen being displayed in the display area when a third application program different from the first and second application programs is run, the selection screen showing arrangement of display signs representing the respective application programs.

12. The portable apparatus according to claim 10, wherein
the detection module is further configured to detect an operation performed by the user on the display area, and
the first input is a first operation performed on the display area.

13. The portable apparatus according to claim 9, wherein
if the detection module detects a second input in a case where the portion of the first display screen is displayed in the main area, and the portion of the second display screen is displayed in the sub area, the at least one processor ends display of the portion of the second display screen, and displays the first display screen in the display area as a whole.

14. The portable apparatus according to claim 13, wherein
the detection module is further configured to detect an operation performed by the user on the display area, and
the second input is a second operation performed by the user on the main area.

15. The portable apparatus according to claim 9, wherein
if the detection module detects a third input in a case where the portion of the first display screen is displayed in the main area, and the portion of the second display screen is displayed in the sub area, the at least one processor ends display of the portion of the first display screen, and displays the second display screen in the display area as a whole.

16. The portable apparatus according to claim 15, wherein
the detection module is further configured to detect an operation performed by the user on the display area, and
the third input is a second operation performed by the user on the sub area.

17. The portable apparatus according to claim 9, wherein
if the detection module detects an operation performed on any one of display signs representing the respective application programs in the main area in a case where a portion of a selection screen showing arrangement of the display signs is displayed in the main area, the at least one processor runs a fourth application program corresponding to the one of display signs on which the operation is performed, and displays a portion of a fourth display screen in the sub area, the fourth display screen being displayed when the fourth application program is run.

18. The portable apparatus according to claim 17, wherein
when the at least one processor displays the selection screen in the display area as a whole in a case where the portion of the selection screen is displayed in the main area, and the portion of the fourth display screen is displayed in the sub area, the at least one processor ends the fourth application program.

19. A method for controlling a portable apparatus comprising:
displaying a display screen in a display area on the front face of a housing of the portable apparatus;
detecting a contact location of a holding finger holding the housing;
detecting a tilt angle of housing; and
translating, if a change in the contact location and a change in the tilt angle of the housing are both detected, the display screen in a direction away from the contact location, and displaying the display screen in the display area.
